(19) United States
(12) Patent Application Publication
(10) Pub. No.: US 2015/0062162 A1
(43) Pub. Date: Mar. 5, 2015

(54) PORTABLE DEVICE DISPLAYING AUGMENTED REALITY IMAGE AND METHOD OF CONTROLLING THEREFOR

(71) Applicant: LG ELECTRONICS INC., Seoul (KR)

(72) Inventors: Jihwan KIM, Seoul (KR); Jongho KIM, Seoul (KR); Sinae CHUN, Seoul (KR); Eunhyung CHO, Seoul (KR)

(73) Assignee: LG ELECTRONICS INC., Seoul (KR)

(21) Appl. No.: 14/080,355

(22) Filed: Nov. 14, 2013

(30) Foreign Application Priority Data
Aug. 28, 2013 (KR) 10-2013-0102323

(51) Int. Cl. G06T 19/00

(52) U.S. Cl. CPC G06T 19/006
USPC 345/633

(57) ABSTRACT

A method of controlling a portable device according to one embodiment of the present specification includes detecting a marker, if the marker is detected in a first area of the portable device, displaying at least a part of the augmented reality image based on a position of the detected marker with a first augmented reality mode, wherein the augmented reality image corresponds to the marker and is assigned to a first position and if the detected marker deviates from the first area, displaying the augmented reality image assigned to the first position with a second augmented reality mode, wherein the first augmented reality mode displays the augmented reality image corresponding to the marker while the marker is positioned within the first area and wherein the second augmented reality mode displays the augmented reality image corresponding to the marker in case that the marker deviates from the first area.

Pursuant to 35 U.S.C. §119(a), this application claims the benefit of the Korean Patent Application No. 10-2013-0102323, filed on Aug. 28, 2013, which is hereby incorporated by reference as if fully set forth herein.

### BACKGROUND OF THE INVENTION

1. Field of the Invention

The present specification relates to a portable device, and more particularly, to a portable device displaying a large augmented reality image.

2. Discussion of the Related Art

An augmented reality technology of which a real object and a virtual object are mixed together enables a user to see a real image together with an augmented reality image and then provides additional information in addition to a sense of reality. For instance, if a user holds a camera of a smartphone to surroundings, such augmented reality images as a location of a nearby store, a telephone number, and the like are marked as a 3 dimensional image together with a real image. The augmented reality technology can be applied to a wearable computer. In particular, such a display put on a head as a head mounted display provides an augmented reality to a user in a manner of overlapping a real environment of which the user currently sees with an augmented reality image, a text, or the like.

An augmented reality image is generated in response to a marker detected by a camera. Hence, if the marker is not detected any more while the augmented reality image is displayed by a device, the augmented reality image cannot be displayed any longer. Hence, a method of displaying the augmented reality image is required in a situation that the marker is not detected by the camera.

### SUMMARY OF THE INVENTION

Accordingly, the present specification is directed to an apparatus and method thereof that substantially obviate one or more problems due to limitations and disadvantages of the related art.

An object of the present specification is to provide a portable device displaying an augmented reality image and a method of controlling therefor. In particular, while the augmented reality image is displayed by the portable device, it is necessary to provide a method of maintaining the displayed augmented reality image although a marker is not detected any more in the present specification.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a portable device includes a camera unit configured to detect a marker, a display unit configured to display at least a part of an augmented reality image corresponding to the detected marker, and a controller configured to control the camera unit and the display unit, if the marker is detected in a first area, the controller configured to display the augmented reality image based on a position of the detected marker with a first augmented reality mode, wherein the augmented reality image corresponds to the marker and is assigned to a first position, if the detected marker deviates from the first area, the controller configured to display the augmented reality image assigned to the first position with a second augmented reality mode, wherein the first augmented reality mode displays the augmented reality image corresponding to the marker while the marker is positioned within the first area and wherein the second augmented reality mode displays the augmented reality image corresponding to the marker in case that the marker deviates from the first area.

To achieve these and other advantages and in accordance with the purpose of the present specification, as embodied and broadly described, according to one embodiment, a method of controlling a portable device includes the steps of detecting a marker, if the marker is detected in a first area of the portable device, displaying at least a part of the augmented reality image based on a position of the detected marker with a first augmented reality mode, wherein the augmented reality image corresponds to the marker and is assigned to a first position, and if the detected marker deviates from the first area, displaying the augmented reality image assigned to the first position with a second augmented reality mode, wherein the first augmented reality mode displays the augmented reality image corresponding to the marker while the marker is positioned within the first area and wherein the second augmented reality mode displays the augmented reality image corresponding to the marker in case that the marker deviates from the first area.

According to the present specification, a portable device can display an augmented reality image even in a case that a marker is not detected.

According to the present specification, a portable device can display an augmented reality image exceeding a size of a display unit.

According to the present specification, a portable device can display an indicator for a not displayed part of an augmented reality image.

According to the present specification, a portable device can display an indicator indicating a position of a marker.

According to the present specification, a portable device can display an image of a marker in a manner of copying the marker from which deviates a detecting region.

According to the present specification, a portable device can display a large augmented reality image as an indicator in a manner of reducing the large augmented reality image.

According to the present specification, a portable device can display an indicator indicating a position of an augmented reality image.

According to the present specification, a portable device can fade out a displayed augmented reality image according to time in a situation that a marker is not detected.

It is to be understood that both the foregoing general description and the following detailed description of the present specification are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for a method of displaying an augmented reality image with a first augmented reality mode of a portable device according to one embodiment of the present specification;

FIG. 2 is a diagram for a method of displaying an augmented reality image with a second augmented reality mode of a portable device according to one embodiment of the present specification;

FIG. 3 is a diagram for a method of displaying an augmented reality image with a second augmented reality mode of a portable device according to a different embodiment of the present specification;

FIG. 4 is a diagram for a method of displaying an augmented reality image with a second augmented reality mode of a portable device according to a different embodiment of the present specification;

FIG. 5 is a diagram for a method of displaying an augmented reality image with a second augmented reality mode of a portable device according to a different embodiment of the present specification;

FIG. 6 is a block diagram of a portable device according to one embodiment of the present specification;

FIG. 7 is a flowchart for a method of controlling a portable device according to one embodiment of the present specification.

### DETAILED DESCRIPTION OF THE INVENTION

While the embodiments have been concretely described with reference to the attached diagrams and the contents written on the diagrams, a scope of claims may be non-restricted or non-limited to the embodiments.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

In the present specification, a portable device may include a head mounted display, a smartphone, a smart pad, a tablet computer, a notebook, a music player, or a foldable display device. And, an augmented reality image may include a graphic image, a text, a symbol, and an emoticon.

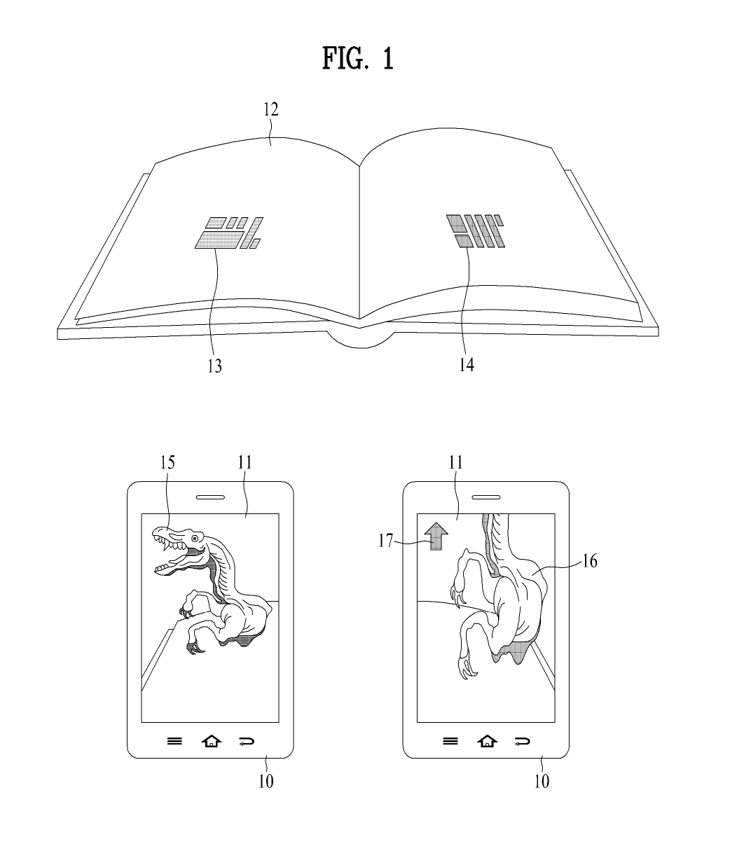

FIG. 1 is a diagram for a method of displaying an augmented reality image with a first augmented reality mode of a portable device according to one embodiment of the present specification. The portable device detects a marker in a first area and can display an augmented reality image corresponding to the marker. In this case, the first area may mean an area displayed in a display unit of the portable device. According to embodiment, the first area may mean an area, which is taken by a camera unit of the portable device. If the marker is detected, the portable device can operate in the first augmented reality mode. In the first augmented reality mode, the portable device can display the augmented reality image while the marker is detected. If the marker is not detected any more in the first augmented reality mode, the portable device can eliminate the displayed augmented reality image from the display area. In particular, the portable device can maintain the first augmented reality mode while the marker is displayed in the display unit. Or, the portable device can maintain the first augmented reality mode while the marker is included in a detecting region of the camera unit.

Referring to FIG. 1, the portable device 10 can include a display unit 11 configured to display a marker. And, the portable device can include a camera unit configured to detect the marker. The portable device can take a picture of a real object 12 using the camera unit. The portable device can display an image of the captured real object in the display unit. A surface of the real object 12 can include a first marker 13 and a second marker 14 corresponding to a first augmented reality image and a second augmented reality image, respectively.

Referring to the left bottom of FIG. 1, the portable device can detect the first marker 13. The portable device detects the first marker by taking a picture of the first marker 13 using the camera unit or the portable device can detect the first marker by displaying the first marker in the display unit 11. Having detected the first marker, the portable device 10 can display the first augmented reality image 15 corresponding to the first marker. If a size of the first augmented reality image 15 is smaller than the display area of the display unit 11, the portable device 10 can display a whole area of the first augmented reality image 15.

Referring to the right bottom of FIG. 1, the portable device can detect a second marker 14. The portable device detects the second marker by taking a picture of the second marker 14 using the camera unit or the portable device can detect the second marker by displaying the second marker in the display unit 11. Having detected the second marker, the portable device 10 can display the second augmented reality image 16 corresponding to the second marker. The second augmented reality image 16 corresponding to the second marker can exceed the size of the display area of the portable device. The present specification can define the augmented reality image exceeding the size of the display area of the portable device as a large augmented reality image.

If a size of the second augmented reality image 16 exceeds the size of the display area of the display unit 11 of the portable device, the portable device 10 can display a part of the second augmented reality image 16. And, the portable device 10 can further display an indicator 17 indicating that there exists the rest of the second augmented reality image except the displayed part of the second augmented reality image 16. A user checks the indicator 17 and can recognize that the displayed second augmented reality image is a part of a whole image and there exists a part of the not displayed second augmented reality image.

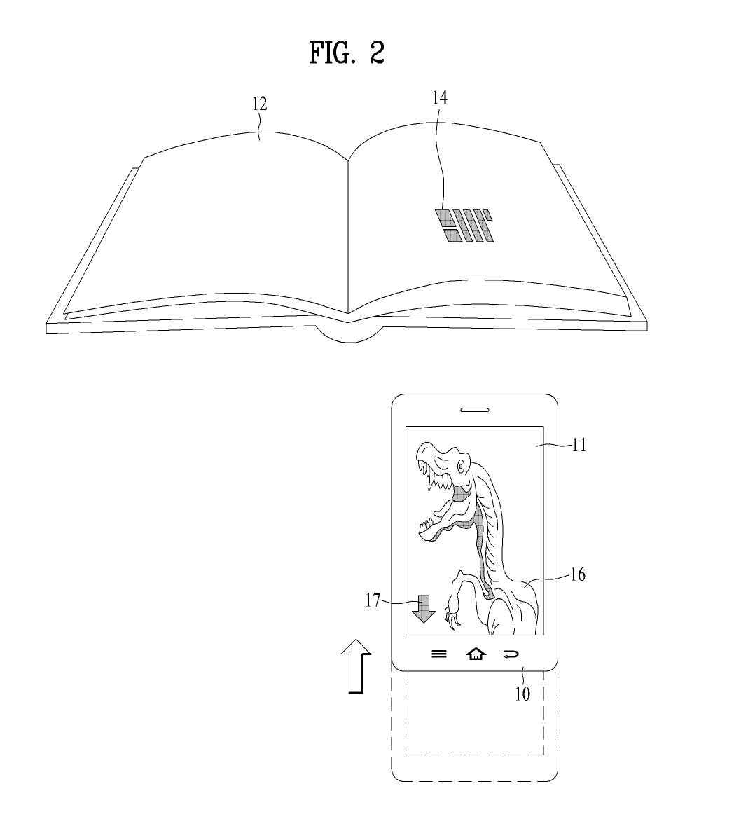

The indicator 17 can indicate a direction at which the part of the not displayed second augmented reality image is positioned. Since the indicator 17 indicates an upward direction in the right bottom of FIG. 2, if the portable device is moved to the upward direction, the rest of the not displayed augmented reality image can be displayed.

The portable device can activate a first timer in the first augmented reality mode. The portable device can eliminate a displayed augmented reality image from a first area after a first time elapses from the time on which the first timer is activated. The portable device can gradually eliminate the augmented reality image during the first time in the first augmented reality mode. In a second augmented reality mode described later, the portable device activates a second timer. The portable device can eliminate a displayed augmented reality image from the first area after a second time elapses from the time on which the second timer is activated. In this case, the first time cannot exceed the second time.

The portable device can detect that a displayed augmented reality image moves in the first area as the position of the portable device moves. If the portable device detects that the augmented reality image moves in the first area in the first augmented reality mode, the portable device activates a third timer. The portable device can eliminate the displayed augmented reality image from the first area after a third time elapses from the time on which the third timer is activated. If the portable device detects that the augmented reality image moves in the first area in the second augmented reality mode, the portable device activates a fourth timer. The portable device can eliminate the displayed augmented reality image from the first area after a fourth time elapses from the time on which the fourth timer is activated.

In this case, the third time cannot exceed the first time. And, the fourth time cannot exceed the second time. And, the third time cannot exceed the fourth time.

FIG. 2 is a diagram for a method of displaying an augmented reality image with a second augmented reality mode of a portable device according to one embodiment of the present specification. A user checks a part of an augmented reality image displayed in the portable device and can move the portable device to check the rest of the augmented reality image not displayed. By doing so, the portable device can display the rest of the augmented reality image. If the portable device moves, the portable device may not detect a marker any more. If the portable device does not detect the marker in a first area, the portable device can operates in the second augmented reality mode. In this case, the first area may mean an area displayed in a display unit of the portable device. According to embodiment, the first area may mean an area, which is taken by a camera unit of the portable device.

After detecting that the marker detected in the first augmented reality mode is disappeared, the portable device can start the second augmented reality mode. In the second augmented reality mode, the portable device can display an augmented reality image although the marker has deviated from the first area. In particular, unlike the first augmented reality mode, the portable device operating in the second augmented reality mode can maintain the displayed augmented reality image in the display area in case that the marker is not detected any more.

Referring to the right bottom of FIG. 1, the portable device 10, which detects a second marker and displays a part of a second augmented reality image corresponding to the second marker, can be moved to an upward direction to display the rest of the second augmented reality image. As depicted in FIG. 2, the portable device 10 can display the rest of the second augmented reality image 16 at a moved position. The portable device 10 cannot detect the second marker 14 in the first area at the moved position. In particular, the portable device 10 cannot display the second marker in the display unit 11. Or, the portable device 10 cannot take a picture of the second marker in the area of which the camera unit takes a picture. Having not detected the second marker 14, the portable device can operate in the second augmented reality mode. In the second augmented reality mode, if the second marker deviates from the first area, the portable device 10 can maintain the displayed second augmented reality image 16.

The portable device can display an indicator 17 indicating a position of the second marker 14. Referring to FIG. 2, since the portable device has moved to an upward direction from the position of the second marker, the portable device can display the indicator 17 indicating a downward direction.

The portable device can display an indicator indicating that the portable device operates in the second augmented reality mode. The portable device can display an image effect for the second augmented reality image 16 with an indicator. The portable device can display such an image processing as a highlighting or a blurring the second augmented reality image 16 with an indicator.

As mentioned in the foregoing description, the portable device can display or maintain the second augmented reality image corresponding to the second marker using the second augmented reality mode in case that the second marker is not detected. And, the portable device can inform a user of a direction at which the second marker corresponding to the displayed second augmented reality image is positioned by displaying the indicator indicating the position of the second marker in the second augmented reality mode.

The user can move the portable device operating in the second augmented reality mode to detect the second marker in the first area. If the portable device detects the identical second marker again, the portable device can switch the second augmented reality mode to the first augmented reality mode. The portable device can display the second augmented reality image corresponding to the second marker.

If the portable device detects not the identical second marker but a third marker, the portable device switches the second augmented reality mode to the first augmented reality mode and can display a third augmented reality image corresponding to the third marker. In this case, the portable device can eliminate the displayed second augmented reality image from the display area.

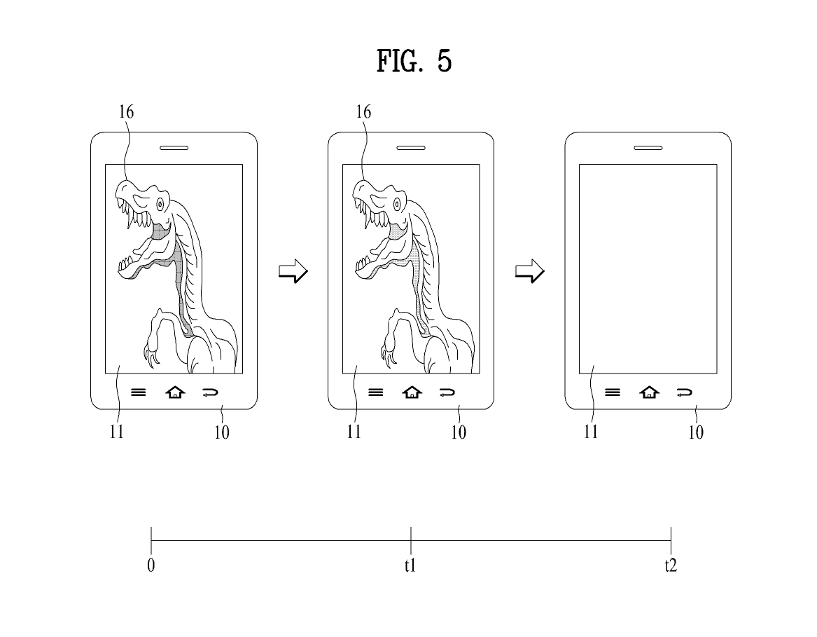

The portable device can activate a second timer in the second augmented reality mode. The portable device can eliminate the augmented reality image, which is displayed after a second time elapses from the time on which the second timer is activated, from the first area. The first time described in FIG. 1 can exceed the second time. Embodiment for the second timer shall be explained in detail in FIG. 5.

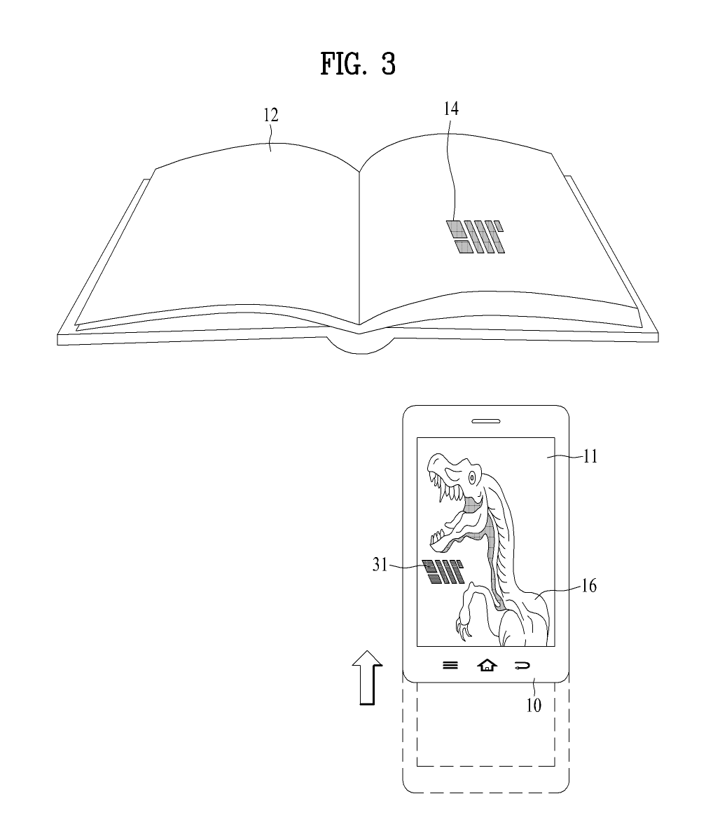

FIG. 3 is a diagram for a method of displaying an augmented reality image with a second augmented reality mode of a portable device according to a different embodiment of the present specification. The portable device can display a copied image of a marker in the second augmented reality mode. When the portable device operates in the second augmented reality mode, the portable device cannot detect the marker in the first area. In particular, the portable device operating in the second augmented reality mode cannot detect the marker with the camera unit or cannot display an image of the marker in the display unit. Hence, the portable device stores the image of the marker while operating in the first augmented reality mode. The portable device can display the copied image of the marker in a manner of loading the stored image of the marker while operating in the second augmented reality mode.

Referring to the right bottom of FIG. 1, the portable device detects the second marker and displays a part of the second augmented reality image corresponding to the second marker. The portable device 10 can be moved to an upward direction to display the rest of the second augmented reality image. As depicted in FIG. 3, the portable device can display the rest of the second augmented reality image 16 at a moved position. The portable device 10 cannot detect the second marker 14 in the first area at the moved position. In particular, the portable device 10 cannot display the second marker in the display unit 11. Or, the portable device cannot take a picture of the second marker in the area of which the camera unit takes a picture. Having not detected the second marker 14, the portable device can operate in the second augmented reality mode. In the second augmented reality mode, the portable device 10 can maintain the displayed second augmented reality image 16 in case that the second marker deviates from the first area.

The portable device 10 can display a copied image 31 of the second marker 14, which is detected at the position before the portable device has moved, after the portable display has moved. In particular, the portable device 10 can detect the second marker and can store an image of the second marker in the first augmented reality mode. The portable device can display the stored image of the second marker as the copied image 31 of the second marker in the second augmented reality mode. The portable device 10 can indicate that which marker corresponds to the displayed second augmented reality image 16 in a manner of displaying the copied image 31 of the second marker. By doing so, a user can recognize a correlation between a marker and an augmented reality image corresponding to the marker.

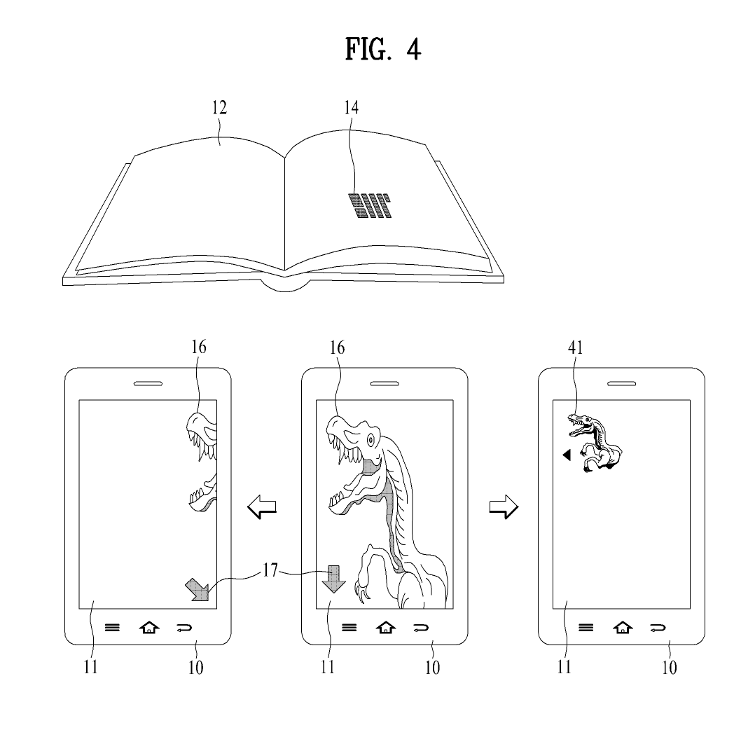

FIG. 4 is a diagram for a method of displaying an augmented reality image with a second augmented reality mode of a portable device according to a different embodiment of the present specification. The portable device can maintain or cancel the second augmented reality mode according to an extent of deviating from the augmented reality image displayed in the second augmented reality mode. And, the portable device can determine whether an augmented reality image is displayed or an indicator of the augmented reality image is displayed according to whether the augmented reality image displayed in the second augmented reality mode is continuously displayed. According to embodiment, the portable device can determine whether the augmented reality image is displayed or the indicator of the augmented reality image is displayed according to the extent of deviating from the augmented reality image displayed in the second augmented reality mode.

The portable device 10 can determine a position of an augmented reality image according to a position of a marker. Hence, if the portable device 10 moves under a situation that the position of the marker is fixed, a part of the augmented reality image displayed in the portable device 10 can change.

Referring to the middle bottom of FIG. 4, the portable device 10 can display a second augmented reality image 16 with the second augmented reality mode. The portable device can further display an indicator 17 indicating a position of a marker. Compared to the right bottom of FIG. 1, since a second marker is positioned at a downward direction of the portable device, the portable device 10 can display an arrow indicating the downward direction as the indicator.

The portable device can determine a position of the second augmented reality image according to a position of the second marker 14. Hence, if the portable device 10 moves under a situation that the position of the second marker is fixed, the area of the second augmented reality image displayed in the portable device can change.

As depicted in the left bottom of FIG. 4, if a part of the second augmented reality image 16 is still displayed after the portable device 10 has moved, the portable device can maintain the second augmented reality mode. If the portable device 10 moves to the left, the second augmented reality image 16 can be displayed in a manner of being moved to the right. The second marker 14 can be positioned at a right downward direction of the portable device on the basis of a moved position of the portable device. Hence, the portable device 10 can display an arrow indicating the right downward direction as an indicator 17.

As depicted in the right bottom of FIG. 4, in case that the portable device 10 moves within a first angle or a first distance and then the second augmented reality image is not displayed any more, the portable device can maintain the second augmented reality mode. In this case, the portable device 10 can display an indicator 41 of the second augmented reality image. The portable device can display at least one of a graphic image indicating the second augmented reality image and a graphic image indicating a position of the second augmented reality image as the indicator 41. For instance, the portable device 10 can display at least one of a reduced image of the second augmented reality image and an image indicating a direction at which the second augmented reality image is positioned as the indicator 41. If the portable device 10 moves to the position at which the second augmented reality image is positioned while the second augmented reality mode is maintained, the portable device 10 can display the second augmented reality image. In particular, the portable device 10 operating in the second augmented reality mode, which has moved within the first angle or the first distance, can display the second augmented reality image although the portable device does not detect the second marker 14 corresponding to the second augmented reality image 16.

If the portable device 10 moves more than the first angle or the first distance, the portable device can cancel the second augmented reality mode. In other word, if the portable device moves to a second angle or a second distance, which exceeds the first angle or the first distance, respectively, the portable device can cancel the second augmented reality mode. In this case, the first angle may be less than the second angle.

If the portable device moves to a position at which the second augmented reality image is positioned in a state that the second augmented reality mode is canceled, the portable device 10 cannot display the second augmented reality image. The portable device 10 canceled from the second augmented reality mode cannot display the second augmented reality image until the portable device detects the second marker 14 corresponding to the second augmented reality image 16 again.

FIG. 5 is a diagram for a method of displaying an augmented reality image with a second augmented reality mode of a portable device according to a different embodiment of the present specification. The portable device can eliminate an augmented reality image displayed in the second augmented reality mode from the display unit after a preconfigured second time elapses. If the second time elapses after the second augmented reality mode is started using a timer, the portable device can eliminate the displayed augmented reality image from the display unit.

Referring to the left top of FIG. 5, the portable device operating in the second augmented reality mode can display a second augmented reality image 16. If t2 time, which is the second time, elapses, as depicted in the right top of FIG. 5, the portable device can eliminate the second augmented reality image from the display unit. And, as time goes by from 0 to the t2 time, the portable device can add an image effect to the second augmented reality image. For instance, the portable device can gradually fade out the second augmented reality image from 0 to the t2 time. In particular, the portable device can blurredly display the second augmented reality image as depicted in the middle top of FIG. 5 on a t1 time between 0 and the t2 time. As a different embodiment, as time goes by from 0 to the t2, the portable device can blur the second augmented reality image or can switch the second augmented reality image to a different image.

The portable device can inform a user that the second augmented reality image is displayed by the second augmented reality mode in a manner of eliminating the second augmented reality image from the display unit as time goes by. And, the portable device can inform the user that the second augmented reality image is going to be eliminated from the display unit in a manner of gradually fading out the second augmented reality image. The user can prevent the second augmented reality image from being eliminated by moving the portable device to make the portable device detect the second marker corresponding to the second augmented reality image in the first area before the second augmented reality image is eliminated.

If the second marker is detected in the first area after a timer is activated, the portable device can reset the timer. According to embodiment, the portable device can inactivate the timer instead of resetting the timer. The reset or inactivated timer is activated again when the second marker deviates from the first area.

If the second time elapses after the second augmented reality mode is started, and then if the second augmented reality image is eliminated, the portable device can terminate the second augmented reality mode.

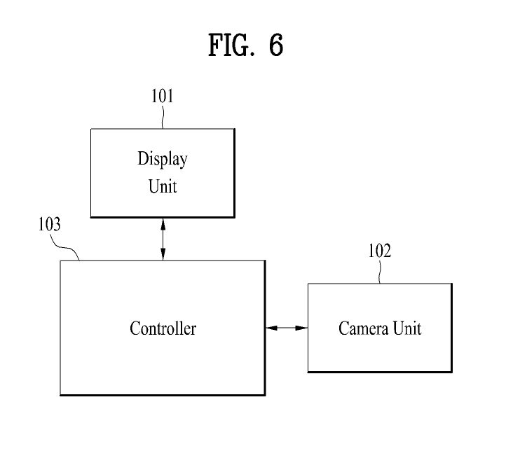

FIG. 6 is a block diagram of a portable device according to one embodiment of the present specification. The portable device can include a display unit 101, a camera unit 102, and a controller 103.

The display unit 101 can display a marker and an augmented reality image corresponding to the marker. The display unit 101 can display an image of a real object detected by the camera unit. The real object can include the marker. The display unit can display the augmented reality image corresponding to the marker in a manner of adding to the image of the real object. If the portable device corresponds to a head mounted display, the real object image may not be displayed. If the portable device corresponds to the head mounted display, the portable device can display the augmented reality image in an object of a real world of which a user sees via a see-through glass.

According to embodiment, the display unit 101 can include at least one selected from the group consisting of an organic light-emitting diode (OLED), a liquid crystal display (LCD), an E-ink, a projector, and a flexible display.

The camera unit 102 is configured to take a picture of surroundings of the portable device and can generate an image of a real object with the captured surroundings. The image of the real object can include a marker. The camera unit 102 detects the marker included in the image of the real object and can deliver the marker to the controller. If the image of the real object includes a plurality of markers, the camera unit 102 detects a plurality of the markers and can deliver information on a plurality of the markers to the controller.

The controller 103 can control the display unit 101 and the camera unit 102 using the information delivered from the camera unit 102. The controller 103 can detects a marker in the image of the real object displayed in the display unit 101 or in the image of the real object generated by the camera unit 102.

If the marker is detected, the controller 103 can activate a first augmented reality mode of the portable device. The controller 103 can display an augmented reality image corresponding to the detected marker in a manner of adding to the image of the real object. If the marker is detected in the first augmented reality mode, the controller 103 can display the augmented reality image. In particular, if the marker is not detected any more, the controller can eliminate the displayed augmented reality image from the display unit.

If the detected marker is not detected any longer, the controller 103 can activate a second augmented reality mode of the portable device. In the second augmented reality mode, although the marker is not detected any more, the controller 103 can maintain the displayed augmented reality image in the display unit. The controller 103 can eliminate the augmented reality image displayed in the second augmented reality mode from the display unit when a second time elapses.

The controller 103 can differentiate a method of displaying the augmented reality image in the second augmented reality mode in consideration of a position of the augmented reality image and a position of the portable device. In the second augmented reality mode, although the marker is not detected any more, the controller 103 can maintain the displayed augmented reality image if at least one part of the augmented reality image can be displayed in the display unit. If no part of the augmented reality image is displayed due to a movement of the portable device, the controller 103 can display an indicator. The controller 103 can display the indicator in a manner of reducing the augmented reality image and can include an image indicating the position of the augmented reality image in the indicator.

If the position of the portable device and the position of the augmented reality image are different from each other more than an angle threshold or a distance threshold, the controller 103 can cancel the second augmented reality mode. If the second augmented reality mode is cancelled, the controller 103 can eliminate the displayed augmented reality image from the display unit.

FIG. 6 is a block diagram according to one embodiment. Blocks represented as being separated are depicted for elements of the portable device in a manner of being logically distinguished. Thus, the aforementioned elements of the portable device may be equipped with a single chip or a plurality of chips according to a design of the portable device.

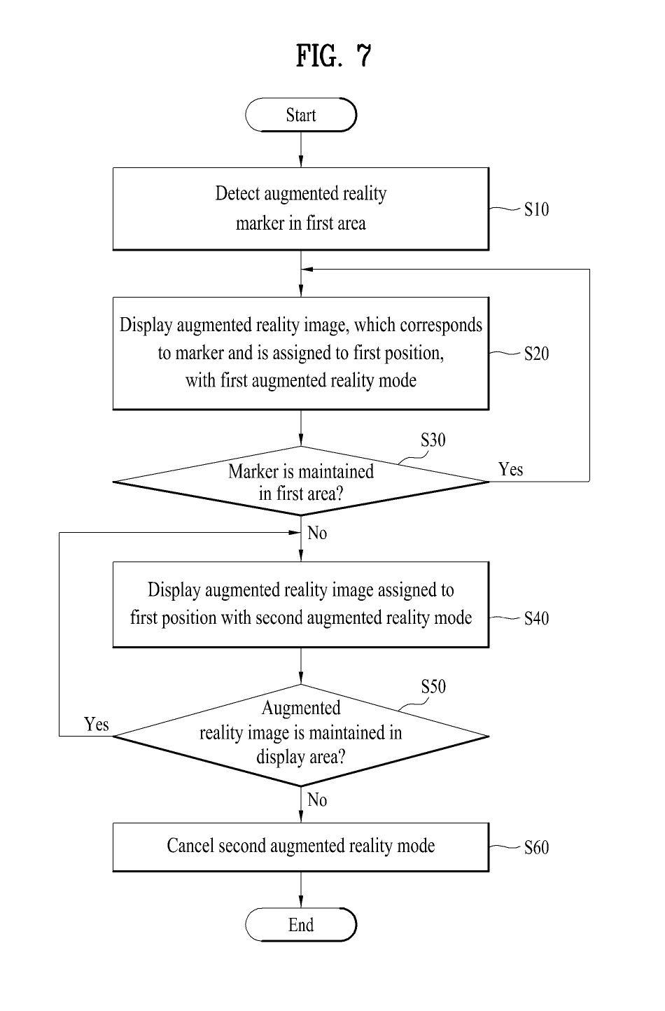

FIG. 7 is a flowchart for a method of controlling a portable device according to one embodiment of the present specification. The portable device can detect a marker in a first area [S10]. In this case, the first area may mean an area in which a display unit of the portable device displays. And, according to embodiment, the first area may mean an area of which a camera unit of the portable device takes a picture. As mentioned earlier in FIG. 1, the portable device can detect a marker by taking a picture of the marker using the camera unit or displaying the marker in the display unit.

The portable device operating in a first augmented reality mode can display an augmented reality image, which corresponds to the marker and is assigned to a first position [S20]. As mentioned earlier in FIG. 1, if the marker is detected, the portable device can operate in the first augmented reality mode. While the marker is detected, the portable device can display the augmented reality image assigned to the first position in the first augmented reality mode. If the marker is not detected any more, the portable device can eliminate the displayed augmented reality image from the display area in the first augmented reality mode.

If a size of the augmented reality image exceeds the display area of the display unit of the portable device, the portable device can display a part of the augmented reality image. The portable device can further display an indicator indicating that there exists the rest of the augmented reality image except the displayed part of the augmented reality image. A user checks the indicator and can recognize that the augmented reality image displayed in the portable device is a part of a whole image and there exists a part of the not displayed augmented reality image. The user can move the portable device according to a direction of the indicator. As the portable device moves according to the direction of the indicator, the portable device can display the part of the not displayed augmented reality image of the augmented reality image assigned to the first position.

The portable device can determine whether the marker is maintained in the first area [S30]. As mentioned earlier in FIG. 2, if the position of the portable device changes, a detecting region of the camera unit and an area displayed in the display unit may change as well. In particular, the first area of the portable device may change.

The portable device can determine whether the marker is detected in a changed first area. The portable device can determine whether the marker is detected in the detecting region of the camera unit. Or, the portable device can determine whether the marker is detected in the display area of the display unit. If the marker is detected by the camera unit or if the marker is displayed by the display unit, the portable device can maintain the first augmented reality mode.

If the marker is not maintained in a first area, the portable device can display the augmented reality image assigned to the first position with a second augmented reality mode [S40]. As mentioned earlier in FIG. 2, if the portable device cannot detect the marker in the first area, the portable device can operate in the second augmented reality mode. In this case, the first area may means an area in which the display unit of the portable device displays. According to embodiment, the first area may mean an area of which the camera unit of the portable device takes a picture.

In the second augmented reality mode, the portable device can display an augmented reality image although the maker deviates from the first area. In particular, unlike the first augmented reality mode, the portable device can maintain the displayed augmented reality image in the display area although the marker is not detected any more.

The portable device can display an indicator indicating a position of the marker. Since the marker is not displayed in the display unit any more according to the position of the portable device, the portable device can inform a user of the position of the marker in a manner of displaying the indicator. And, the portable device can display a copied image of the marker together with the augmented reality image.

The portable device can determine whether the augmented reality image is maintained in the display area [S50]. As mentioned earlier in FIG. 4, the portable device can determine whether the augmented reality image is displayed or the second augmented reality mode is cancelled according to whether the displayed augmented reality image is continuously displayed in the second augmented reality mode. While the augmented reality image assigned to the first position is displayed in the display unit, the portable device can maintain the second augmented reality mode. As the portable device moves, the portable device can display at least one part of the augmented reality image assigned to the first position.

If the augmented reality image is not maintained in the display area, the portable device can cancel the second augmented reality mode [S60]. As mentioned earlier in FIG. 4, if no part of the second augmented reality image is displayed, the portable device can cancel the second augmented reality mode. If the second augmented reality mode is cancelled, although the camera unit of the portable device takes a picture of the first position, an augmented reality image is not displayed. In order for the portable device of which the second augmented reality mode is cancelled to display the augmented reality image, the portable device should detect a marker in the first area.

According to a different embodiment, if no part of the second augmented reality image is displayed, the portable device can display an indicator of the second augmented reality image. The indicator may correspond to a reduced second augmented reality image and may indicate the first position to which the second augmented reality image is assigned. After displaying the indicator, if a distance or an angle between the portable device and the first position is more separated, the portable device can cancel the second augmented reality mode at last.

As mentioned in the foregoing description, the portable device of the present specification can display the augmented reality image corresponding to the marker for more than a prescribed time even in a situation that the marker is not detected.

It will be apparent to those skilled in the art that various modifications and variations can be made in the present specification without departing from the spirit or scope of the inventions. Thus, it is intended that the present specification covers the modifications and variations of this invention provided they come within the scope of the appended claims and their equivalents.

What is claimed is:

1. A portable device, comprising:
a camera unit configured to detect a marker;
a display unit configured to display at least a part of an augmented reality image corresponding to the detected marker; and
a controller configured to:
if the marker is detected in a first area, display the augmented reality image based on a position of the detected marker with a first augmented reality mode, wherein the augmented reality image corresponds to the marker and is assigned to a first position, and
if the marker deviates from the first area, display the augmented reality image assigned to the first position with a second augmented reality mode,
wherein the first augmented reality mode displays the augmented reality image corresponding to the marker while the marker is positioned within the first area and wherein the second augmented reality mode displays the augmented reality image corresponding to the marker in case that the marker deviates from the first area.

2. The portable device of claim 1, wherein if the augmented reality image deviates from the first area by a first angle, the controller is configured to maintain the second augmented reality mode and configured to additionally display a first indicator corresponding to the augmented reality image in the first area.

3. The portable device of claim 2, wherein if the augmented reality image existing in the first position deviates from the first area by a second angle, the controller is configured to cancel the second augmented reality mode.

4. The portable device of claim 3, wherein the first indicator corresponds to a reduced image of the augmented reality image and wherein the first angle is less than the second angle.

5. The portable device of claim 1, wherein the first area corresponds to a display area of the display unit and wherein the first augmented reality mode is maintained while the marker is displayed in the display unit.

6. The portable device of claim 1, wherein the first area corresponds to a detecting region of the camera unit and wherein the first augmented reality mode is maintained while the marker is included in the detecting region of the camera unit.

7. The portable device of claim 1, wherein the controller is configured to further display a second indicator indicating the second augmented reality mode.

8. The portable device of claim 7, wherein the second indicator comprises an image processing such as a highlighting or blurring the augmented reality image.

9. The portable device of claim 7, wherein the second indicator indicates a position of the marker.

10. The portable device of claim 1, wherein the controller is configured to activate a first timer in the first augmented reality mode, wherein the controller is configured to eliminate the displayed augmented reality image from the first area after a first time elapses from time on which the first timer is activated, wherein the controller is configured to activate a second timer in the second augmented reality mode, and wherein the controller is configured to eliminate the displayed augmented reality image from the first area after a second time elapses from time on which the second timer is activated.

11. The portable device of claim 10, wherein if the marker deviated from the first area is detected again in the first area in the second augmented reality mode, the controller is configured to deactivate the second timer.

12. The portable device of claim 10, wherein the displayed augmented reality image gradually fades out during the first time in the first augmented reality mode and during the second time in the second augmented reality mode.

13. The portable device of claim 12, wherein the first time exceeds the second time.

14. The portable device of claim 10, wherein the controller is configured to detect that the augmented reality image moves in the first area, wherein the controller is configured to activate a third timer in the first augmented reality mode, wherein the controller is configured to eliminate the displayed augmented reality image from the first area after a third time elapses from time on which the third timer is activated, wherein the controller is configured to activate a fourth timer in the second augmented reality mode, wherein the controller is configured to eliminate the displayed augmented reality image from the first area after a fourth time elapses from time on which the fourth timer is activated, wherein the third time exceeds the first time, and wherein the fourth time exceeds the second time.

15. The portable device of claim 1, wherein if a size of the augmented reality image exceeds a size of the first area, the controller is configured to further display a third indicator and wherein the third indicator indicates existence of a part not displayed in the display unit among the augmented reality image.

16. The portable device of claim 1, wherein if a first marker different from the marker is detected in a position in which the marker is detected, the controller is configured to eliminate the augmented reality image corresponding to the marker.

17. The portable device of claim 1, wherein the controller is configured to display a copied image of the detected marker together with the augmented reality image in the second augmented reality mode.

18. The portable device of claim 1, wherein a size of the augmented reality image exceeds a size of the display area and wherein the display unit is configured to display a part of the augmented reality image.

19. The portable device of claim 1, wherein the second augmented reality mode starts after detecting that the marker is disappeared from the first area in the first augmented reality mode.

20. A method of controlling a portable device, comprising the steps of:
detecting a marker;
if the marker is detected in a first area of the portable device, displaying at least a part of the augmented reality image based on a position of the detected marker with a first augmented reality mode, wherein the augmented reality image corresponds to the marker and is assigned to a first position; and
if the detected marker deviates from the first area, displaying the augmented reality image assigned to the first position with a second augmented reality mode,
wherein the first augmented reality mode displays the augmented reality image corresponding to the marker while the marker is positioned within the first area and wherein the second augmented reality mode displays the augmented reality image corresponding to the marker in case that the marker deviates from the first area.
